(19) United States
(12) Patent Application Publication
(10) Pub. No.: US 2022/0040908 A1
(43) Pub. Date: Feb. 10, 2022

(54) RIBLET FILM AND METHOD FOR THE PRODUCTION THEREOF

(71) Applicant: Lufthansa Technik AG, Hamburg (DE)

(72) Inventors: Kai-Christoph Pfingsten, Hamburg (DE); Andreas Seul, Weilerswist (DE)

(21) Appl. No.: 17/424,171

(22) PCT Filed: Jan. 22, 2020
(86) PCT No.: PCT/EP2020/000022

§ 371 Date: Jul. 20, 2021

(30) Foreign Application Priority Data
Jan. 22, 2019 (DE) 10 2019 101 485.9

(51) Int. Cl. B29C 59/02; B29C 59/00; F15D 1/00

(52) U.S. Cl. CPC B29C 59/026; B29C 59/005; B64C 21/10; F15D 1/0085; B29C 2059/023; F15D 1/0035

(57) ABSTRACT

A riblet film has a riblet structure on a first side of the riblet film; and a fixing surface on a second side of the riblet film. The riblet film is formed from a cured embossing lacquer, in which a planar textile is embedded, and in which the riblet structure is embossed.

### CROSS REFERENCE TO RELATED APPLICATIONS

This application is a U.S. National Phase application under 35 U.S.C. § 371 of International Application No. PCT/EP2020/000022, filed on Jan. 22, 2020, and claims benefit to German Patent Application No. DE 10 2019 101 485.9, filed on Jan. 22, 2019. The International Application was published in German on Jul. 30, 2020 as WO 2020/151907 A1 under PCT Article 21(2).

### FIELD

The invention relates to a riblet film and to a method for the production thereof.

### BACKGROUND

Riblet structures are microstructures of surfaces used to reduce the frictional drag for fluids flowing along the surface—what is known as wall friction. Corresponding structures are generally of interest for applications in which the wall friction makes up a significant proportion of the total flow-induced resistance. Riblet structures are thus located, for example, on outer surfaces of aircraft, but also on rotor blades of wind turbines, on the outer skin of ships, or on outer surfaces of high-speed trains. Structures of this type are likewise used for example on inner surfaces of pipelines.

By means of corresponding riblet structures, the wall friction, and thus also the total air resistance of an aircraft in flight, can thus be reduced, which leads inter alia to lower fuel costs. The same applies for other applications of riblet structures.

In the prior art, various possibilities as to how riblet structures can be applied to already existing structures, such as the painted outer skin of aircraft, are known.

In a first example, the riblet structure is applied as an additional lacquer layer to an already existing aircraft paint layer, wherein what is known as an embossing lacquer, in which a microstructured surface is embossed before or during the curing to form the desired riblets, is used as a lacquer.

In this first example, it is disadvantageous that the riblet layer cannot be regularly removed from the aircraft paint layer in a non-destructive manner—for example in the event of damage by striking particles, such as grains of sand, hail, etc.—and therefore reproducing a riblet structure generally requires the aircraft to be completely refinished in this region.

Alternatively, in another example, the embossing lacquer may be applied to an intermediate film and to structure, and this lacquer may be cured before the riblet film produced in this manner is adhered, for example, to the outer skin of an aircraft.

Even if this film can be regularly detached from the aircraft paint again without damaging this paint, a riblet structure produced in this manner is disadvantageous as a result of the relatively high weight due to providing the intermediate film. The connection between the intermediate film and the embossing lacquer layer is often problematic because the embossing lacquer firstly is to be rigidly connected to the intermediate film, but at the same time, in principle, must not adhere to the embossing tool, which also interacts with the embossing lacquer, in order to ensure the best possible microstructure.

In order to reduce the problem of the connection between the embossing lacquer and the intermediate film, an additional layer—for example an adhesive layer—may be provided between the embossing lacquer and the intermediate film, which, firstly, is rigidly connected to the intermediate film and to which, and secondly, the embossing lacquer adheres well. However, a riblet film of this type has a relatively high weight.

### SUMMARY

In an embodiment, the present disclosure provides a riblet film that has a riblet structure on a first side of the riblet film; and a fixing surface on a second side of the riblet film. The riblet film is formed from a cured embossing lacquer, in which a planar textile is embedded, and in which the riblet structure is embossed.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a-e: show an exemplary embodiment of a production method according to the invention for a riblet film according to the invention;

FIG. 2: shows the use of the riblet film produced according to FIG. 1; and

FIGS. 3a-d: show examples of possible designs of the planar textile used in the method according to FIG. 1.

### DETAILED DESCRIPTION

Embodiments of the present invention provide a riblet film and a method for the production thereof in which the disadvantages known from the prior art can be prevented or at least reduced.

The present invention provides, in an embodiment, a riblet film comprising a riblet structure on a first side of the film and a fixing surface on the second side of the film, wherein the riblet film is formed from cured embossing lacquer, in which a planar textile is embedded and in which the riblet structure is embossed.

A method, according to an embodiment the present invention, for producing a riblet film comprises:

a) surrounding a planar textile with embossing lacquer;
b) embossing the riblet structure in the embossing lacquer; and
c) curing the embossing lacquer.

Some of the terms used within the scope of the invention will firstly be explained.

A “riblet structure” refers to a microstructured surface, which is designed to reduce the wall friction in the case of flow along the surface relative to a corresponding surface without a riblet structure. In this case, the riblet structure comprises elevations arranged on a base surface, the spacing and/or height of which in each case is less than 1 mm, frequently even less than 200 μm, or even less than 60 μm. In this case, the shape and arrangement of the elevations is adapted to the expected flow and in particular designed for a main flow direction, wherein the elevations are generally designed to be elongated in the direction of the main flow direction. In the case of an aircraft, the main flow direction over the outer wall—which varies locally over the entire outer wall of an aircraft—results for example from the flow around the aircraft during cruise flight.

The term “embossing lacquer” refers to a composition which can be applied in a planar manner by means of a suitable device and can be cured to form a microstructured surface, in particular a riblet-structured surface. Corresponding embossing lacquers are known in the prior art.

The embossing lacquer is cured preferably by means of UV radiation. However, any other curing mechanisms known to a person skilled in the art can also additionally be used. Optionally, thermal curing can also additionally be added, in particular in what are known as dual-cure systems.

The desired microstructured surface on the embossing lacquer is generated before or during the curing thereof by means of a suitable embossing element which has the negative form of the desired surface structure. The embossing element comprises an embossing surface to which the embossing lacquer does not adhere or adheres to only an insignificant extent.

An aspect of the present invention is based on the inventor's recognizing that embossing lacquers are generally suitable for being processed to form a film-type element, which can then be applied, in particular adhered, with an intermediate film to a surface, such as in particular the painted outer skin of an aircraft, in a similar manner to riblet films. In order to achieve sufficient strength of the riblet film, it is provided, according to an aspect of the invention, to embed a planar textile in the riblet film formed from embossing lacquer. By means of the inner, planar textile, firstly the strength and rigidity of the riblet film are increased, which makes handling when applying the film easier by comparison with a theoretical riblet film without an inner, planar textile. At the same time, by means of the inner, planar textile, it is made possible, when necessary—for example because the riblet structure is damaged—for the riblet film to also be regularly detached again well and in particular over a large surface area from the surface to which it is fixed for example with adhesive. Without a corresponding inner, planar textile, a riblet film can be removed from embossing lacquer only with difficulty and a lot of effort because the riblet film would almost inevitably tear into small pieces during the attempt at removal as a result of the material properties of embossing lacquers.

By means of the use, according to an embodiment of the present invention, of a planar textile, which is integrated in the riblet film made of embossing lacquer, in comparison with the embodiments in which the embossing lacquer is applied to a continuous intermediate film, an advantage in terms of weight can regularly be achieved, although this is of course dependent on the material and the design of the planar textile. In this case, a person skilled in the art generally has freedom with regard to the design of the textile, but the material is to be selected in such a way that it connects well to the matrix consisting of the embossing lacquer.

An adhesive layer is preferably applied to the fixing surface of the riblet film. The riblet film can then be processed and in particular applied to a surface similarly to any other adhesive films. The adhesive layer preferably allows a reliably strong adhesive bond for the generally expected loads on the riblet film, but which bond, when necessary, can also be detached again by removing the film with a force component which is perpendicular to the surface to which the riblet film is applied. The latter removal of the riblet film is actually possible as a result of the embedded planar textile provided according to an embodiment of the invention.

The planar textile is preferably a woven fabric or a knitted fabric formed from threads, the crossing threads preferably extending approximately at right angles to one another, and/or the distance between two adjacent threads extending in parallel being at least five times the thread diameter. Although other thread arrangements are of course also possible, the preferred arrangement at right angles of the crossing threads makes it possible to produce the textile in a simple and economical manner. Irrespective of the ultimate arrangement of the individual threads relative to one another, a distance between the individual threads extending in parallel which is greater by comparison with the thread diameter offers advantages in terms of weight. By selecting a suitable material for the textile, the desired strength of the riblet film can further be achieved without any problems.

The distance between the second side of the film and the embedded planar textile is preferably at least 5 μm, and/or the distance between the base surface of the riblet structure on the first side of the film and the embedded planar textile is preferably at least 15 μm.

By means of the corresponding distances, it is firstly ensured that the planar textile is completely embedded in the embossing lacquer. It is secondly ensured that the embedded planar textile does not impair the shaping of the surface of the riblet film on any of the respective sides.

The total thickness of the riblet film is preferably between 30 μm and 120 μm, preferably between 50 μm and 80 μm. It has been found that correspondingly thin riblet films according to embodiments of the invention can readily be produced, are easy to handle for attachment to surfaces and can also easily be detached from the surfaces again.

The riblet film is cut into preferably square patches having a size of between 0.3 m×0.3 m and 1.0×1.0 m. Corresponding patches are easy to handle for example when fitting to the outer surface of aircraft.

In order to produce a riblet film, according to embodiments the invention, the planar textile is introduced into the embossing lacquer before the lacquer is cured. By means of the subsequent complete curing of the embossing lacquer, which is also necessary in particular for fixing the riblet structure, a composite of planar textile and embossing lacquer is then produced.

In order to be able to ensure a desired position of the planar textile in the riblet film, it is preferable, before the ultimate introduction of the planar textile into the embossing lacquer—that is to say the step in which the textile is surrounded by the embossing lacquer—for a base layer to firstly be produced from embossing lacquer, to which layer the planar textile is applied before the textile is subsequently completely surrounded by the embossing lacquer by means of additional embossing lacquer to be applied thereto. By providing a base layer, it is possible to ensure a desired distance of the planar textile from the side of the ultimate riblet film formed by the base layer. The base layer can be cured preferably at least in part before the application of the planar textile thereto. However, in so doing, it must be ensured that, even in such a case, the base layer still connects sufficiently well to the subsequently applied embossing lacquer to be cured.

It is preferable when, in order to produce the riblet film, the embossing lacquer is firstly applied to a substrate to which, at least when cured, the embossing lacquer does not adhere or does not adhere sufficiently for the cured riblet film to be able to be detached from the substrate in a non-destructive manner. When not cured, the embossing lacquer is often free-flowing, and therefore, in this state, it regularly cannot be formed into a self-supporting film. By using a substrate from which the riblet film can be detached after curing the embossing lacquer without causing any damage during production, the riblet film can readily be produced according to embodiments of the invention. As a material for the substrate, in principle the same material which is used for the tool for microstructuring the surface is used to provide the riblet structure. In each case, suitable materials for the different embossing lacquers are known to a person skilled in the art from the prior art.

It is also possible for the substrate in question to be in the form of a film so that the riblet film according to embodiments of the invention in principle can also be produced according to the reel-to-reel principle, in which an embossing lacquer layer, optionally having an already integrated planar textile, is applied to the film-type substrate. If the film-type substrate comprising embossing lacquer is unwound from a first reel then—if it is not yet embedded—the planar textile can optionally be introduced into the not-yet-cured embossing lacquer, and subsequently, the surface can be structured, and the embossing lacquer can be cured in a known manner, before the film-type substrate can be wound together with the cured embossing lacquer then forming the riblet film onto a second reel.

It is possible for the embossing of the riblet structure in the embossing lacquer and the curing of the embossing lacquer to take place at the same time. For UV-curing embossing lacquers, for example the UV-NIL process is known for this purpose, in which nanoimprint lithography (NIL) and ultraviolet radiation are combined.

As already mentioned above, it is preferable, after finishing the riblet film, to apply an adhesive layer on the side facing away from the riblet structure, which results in an adhesive film.

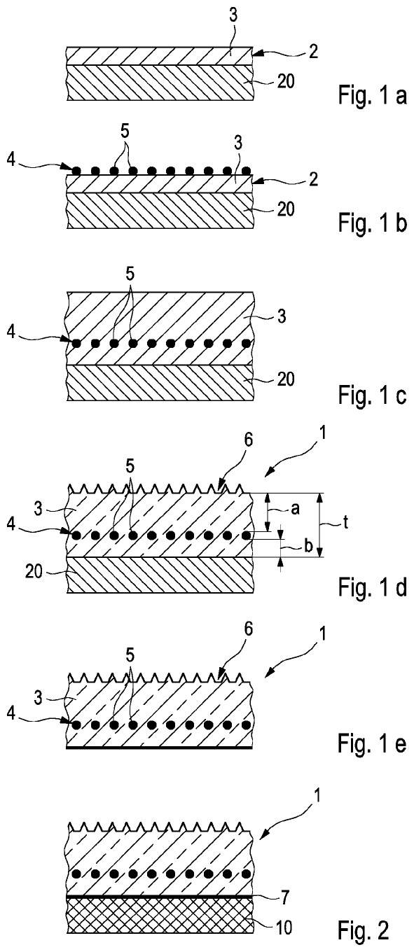

In FIGS. 1a-e, a method for producing a riblet film 1 according to an embodiment of the invention (cf. FIG. 1e) is shown. In this case, FIGS. 1a-e are each sectional views.

At the start of the method, a 5-μm-thick base layer 2 made of an embossing lacquer 3 is formed on a substrate 20 (FIG. 1a). The embossing lacquer 3, which is not yet cured in this stage of the method, or at least not yet cured completely, is highly viscous at least at room temperature and adheres to the substrate 20 in such a way that the substrate 20, together with the base layer 2, in principle can be rolled up together with the base layer 2.

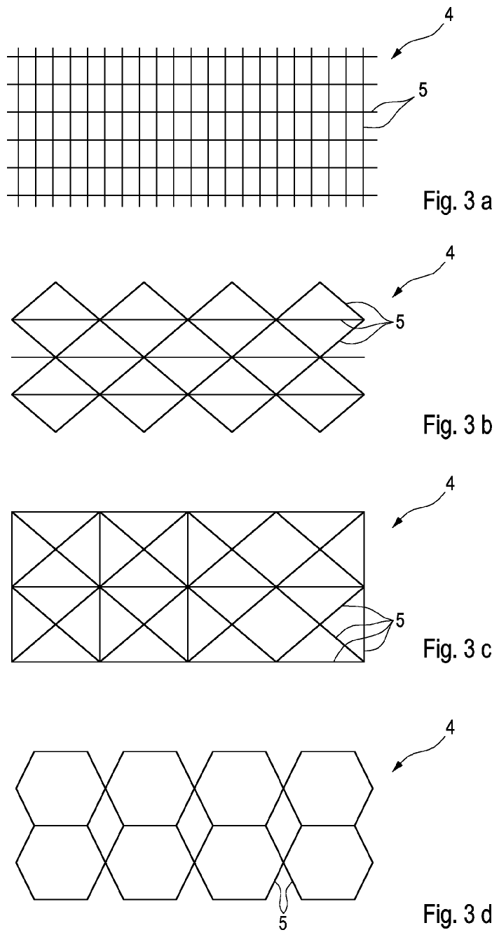

In the step shown in FIG. 1b, a planar textile 4 is applied to the base layer 2. The planar textile 4 is a mesh-type woven fabric made of threads 5 arranged approximately at right angles to one another, wherein the distance between two adjacent threads 5 extending in parallel is approximately five times the thread diameter. The plan view of the planar textile 4 used in FIG. 1 is sketched by way of example in FIG. 3a.

Subsequently, additional embossing lacquer 3 is applied so that the planar textile 4 previously resting on the base layer 2 is completely surrounded by the embossing lacquer 3 and thus embedded therein (FIG. 1). At this stage of the method as well, the embossing lacquer 3 is not yet cured.

The curing of the embossing lacquer 3 (denoted by the different crosshatching) takes place together with the embossing of the riblet structure 6 on the side which is remote from the substrate 20 (FIG. 1d). For the embossing and curing, the methods known from the prior art can be drawn on. In particular, embossing and curing can take place at the same time. Suitable methods for this are also known from the prior art. By curing the embossing lacquer 3, the riblet film 1 according to an embodiment of the invention is provided.

The amount of embossing lacquer 3 applied in the method step sketched in FIG. 1c is selected in such a way that the overall thickness t of the layer of embossing lacquer 3 after the embossing and curing is between 30 μm and 120 μm, preferably between 50 μm and 80 μm. The distance a between the base surface of the riblet structure 6 and the planar textile 4 is at least 15 μm, whereas the distance b between the planar textile 4 and the contact surface to the substrate 20—which can be adjusted by selecting the thickness of the base layer 2 (cf. FIG. 1a)—is 5 μm or more.

The material of the substrate 20 is selected in such a way that, at least after the complete curing of the embossing lacquer 3, the riblet film 1 can be detached therefrom in a non-destructive manner. The side of the riblet film 1 which is then accessible is used as a fixing surface and is provided with an adhesive layer 7, as a result of which the riblet film 1 becomes the self-adhesive film.

The riblet film 1 described according to FIG. 1a-e can be cut into patches in the sizes 0.3×0.3 m and 1.0×1.0 m.

In FIG. 2, the riblet film 1 from FIG. 1 is adhered to a painted outer wall 10 of an aircraft by means of the adhesive layer 7, wherein the arrangement and orientation of the riblet film 1 is selected according to the prior art in order to reduce the air friction during cruise flight.

In FIGS. 3a-d, various possible designs of the planar textile 4 are sketched.

In FIG. 3a, the individual threads 5 of the textile 4 are arranged at right angles to one another. In the exemplary embodiments according to FIGS. 3b and 3c, there are three or four main directions for the individual threads 5. The planar textile 4 according to FIG. 3b is knitted.

In all the exemplary embodiments according to FIG. 3, the distance between adjacent threads 5 extending in parallel is at least five times as great as the diameter of the threads 5.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A riblet film, the riblet film comprising:
a riblet structure on a first side of the riblet film; and
a fixing surface on a second side of the riblet film,
wherein the riblet film is formed from a cured embossing lacquer, in which a planar textile is embedded, and in which the riblet structure is embossed.

2. The ribled film according to claim 1, wherein an adhesive layer is applied to the fixing surface.

3. The riblet film according to claim 1, wherein the planar textile is a woven fabric or a knitted fabric formed from threads.

4. The riblet film according to claim 1, wherein a distance between the second side of the riblet film and the embedded planar textile is at least 5 μm, or a distance between a base surface of the riblet structure on the first side of the film and the embedded planar textile is at least 15 μm.

5. The ribled film according to claim 1, wherein a total thickness of the riblet film is between 30 μm and 120 μm.

6. The riblet film according to claim 1, wherein the riblet film is cut into square patches having a size of between 0.3×0.3 m and 1.0×1.0 m.

7. A method for producing the riblet film according to claim 1, the method comprising:
a) surrounding the planar textile with the embossing lacquer;
b) embossing the riblet structure in the embossing lacquer; and
c) curing the embossing lacquer.

8. The method according to claim 7, the method comprising wherein the following steps carried out before step:
producing a base layer from the embossing lacquer;
curing the base layer at least in part; and
applying the planar textile to the base layer, which is not yet fully cured or is cured at least in part.

9. The method according to claim 7, wherein the embossing lacquer is applied to a substrate to which, at least when cured, the embossing lacquer does not adhere or does not adhere sufficiently for the cured riblet film to be able to be detached from the substrate in a non-destructive manner.

10. The method according to claim 7, wherein the steps and take place at the same time.

11. The method according to claim 7, the method comprising, after finishing the riblet film on a side facing away from the riblet structure-, applying an adhesive layer.

12. The riblet film according to claim 3, wherein the threads extend approximately at right angles to one another, or a distance between two adjacent ones of the threads extending in parallel being at least five times a thread diameter.
